(19) United States
(12) Patent Application Publication
(10) Pub. No.: US 2016/0307219 A1
(43) Pub. Date: Oct. 20, 2016

(54) CUSTOMER LIFECYCLE VISUALIZATION TOOL

(71) Applicant: SugarCRM Inc., Cupertino, CA (US)

(72) Inventors: Karen Hsu, San Mateo, CA (US); Samir Khosla, Cupertino, CA (US); Henry Rogers, Rogers, NC (US); Anwesa Chatterjee, Sunnyvale, CA (US); Wes Moran, Merrimack, NH (US)

(21) Appl. No.: 14/690,465

(22) Filed: Apr. 19, 2015

(51) Int. Cl. G06Q 30/02; G06Q 30/00

(52) U.S. Cl. CPC G06Q 30/0202; G06Q 30/01

(57) ABSTRACT

Embodiments of the present invention provide a method, system and computer program product for customer lifecycle management visualization. In an embodiment of the invention, a method for customer lifecycle management visualization includes defining multiple different stages of a customer lifecycle in a CRM application executing in memory of a computer. The method also includes loading records for a business opportunity from a data store of CRM data stored by way of the CRM application and rendering in a user interface to the CRM application, a visualization of the different stages of the customer lifecycle. Finally, the method includes displaying a state of the business opportunity within the visualization by visually distinguishing ones of the stages already completed in connection with the business opportunity from ones of the stages not yet completed in connection with the business opportunity.

### BACKGROUND OF THE INVENTION

1. Field of the Invention

The present invention relates to customer relationship management (CRM) and more particularly to opportunity management in a CRM application.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

Central to a CRM solution is the notion of a “business opportunity”. A business opportunity in the context of CRM is synonymous with a “sales opportunity” as an element of the “sales pipeline”. A sales pipeline describes an approach to selling, founded on the underlying principles of the sales process. More particularly, the sales pipeline describes the individual steps salespeople undertake from initial contact with a potential customer, or “prospect”, to qualifying that prospect into a lead, and further validating that lead into a sales opportunity followed through the different stages until closed. All sales opportunities arranged along each of the sales steps that make up the sales process represented by the sales pipeline. Thus, a business opportunity is a qualified and validated lead for a potential sale of a product or service.

The concept of a customer lifecycle includes not just the lifecycle of managing a business opportunity or sales opportunity, but also the customer lifecycle includes the lifecycle of managing a customer following the closing of a business opportunity and the conversion of the business opportunity into a customer. More specifically, the customer lifecycle includes lifecycle phases such as purchase support and follow-up, retention and loyalty. Thus, the customer lifecycle in the aggregate includes all phases of the relationship between the organization and its customers, so as to describe how customers are first identified, closed and retained.

Customer lifecycle management usually is a task reserved for each individual sales person. Consequently, the proper management of a customer in the customer lifecycle can rise or fall with the skill and experience of a managing sales person. Sales persons of particular experience can drive a business opportunity to closed and won sale and can retain that customer through the referral by the customer of new customers and through the placement by the customer of new orders. Conversely, a sales person of little experience can drive the same business opportunity to a closed and lost sale, or post-sale to a lost customer. Therefore, providing expert guidance to a sales force can help to ensure that all business opportunities are most likely to result in closed and won sales and all customer are most likely to remain customers.

### BRIEF SUMMARY OF THE INVENTION

Embodiments of the present invention address deficiencies of the art in respect to customer lifecycle management and provide a novel and non-obvious method, system and computer program product for customer lifecycle management visualization. In an embodiment of the invention, a method for customer lifecycle management visualization includes defining multiple different stages of a customer lifecycle in a CRM application executing in memory of a computer. The method also includes loading records for a business opportunity from a data store of CRM data stored by way of the CRM application and rendering in a user interface to the CRM application, a visualization of the different stages of the customer lifecycle. Finally, the method includes displaying a state of the business opportunity within the visualization by visually distinguishing ones of the stages already completed in connection with the business opportunity from ones of the stages not yet completed in connection with the business opportunity.

In one aspect of the embodiment, different tasks in the CRM application completed in connection with the business opportunity are identifying from the loaded records and an aggregate score of the state of the business opportunity computed based upon a sum of individual scores assigned to respectively different ones of the tasks with the aggregate score displayed within the visualization. Optionally, a set of yet to be performed tasks associated with a stage corresponding to the state of the business opportunity is identified from a table of tasks in the CRM application and displayed in the visualization. Even further, a prospective aggregate score is computed based upon the sum of the individual scores and a sum of scores assigned to the yet to be performed tasks the prospective aggregate scored displayed in the visualization in connection with a display of the identified set of yet to be performed tasks.

In another embodiment of the invention, a CRM data processing system is provided. The system includes a host computing system that has one or more computers, each with memory and at least one processor and a CRM application executing in the memory of the host computing system as well as a data store of CRM data coupled to the CRM application. Additionally, a customer lifecycle management visualization tool is coupled to the CRM application. The tool includes program code enabled upon execution in the memory of the host computing system to define multiple different stages of a customer lifecycle in the CRM application, to load records for a business opportunity from the data store, to render in a user interface to the CRM application, a visualization of the different stages of the customer lifecycle, and to display a state of the business opportunity within the visualization by visually distinguishing ones of the stages already completed in connection with the business opportunity from ones of the stages not yet completed in connection with the business opportunity.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for customer lifecycle management visualization;

FIG. 2 is a schematic illustration of a CRM data processing system configured for customer lifecycle management visualization; and,

FIG. 3 is a flow chart illustrating a process for customer lifecycle management visualization.

### DETAILED DESCRIPTION OF THE INVENTION

Embodiments of the invention provide for customer lifecycle management visualization. In accordance with an embodiment of the invention, different stages can be defined for a customer lifecycle in a CRM application. Further, one or more tasks in the CRM application can be specified for each of the stages in furtherance of transitioning from one stage of the customer lifecycle to another. Thereafter, records for a business opportunity can be loaded from a data store of the CRM application and a current one of the stages of the customer lifecycle can be determined for the business opportunity. A visualization of the different stages of the customer lifecycle can be rendered in a user interface to the CRM application and the state of the loaded business opportunity visually expressed within the visualization. Stages already completed for the loaded business opportunity are visually distinguished within the visualization from the stages that are yet to be completed for the loaded business opportunity.

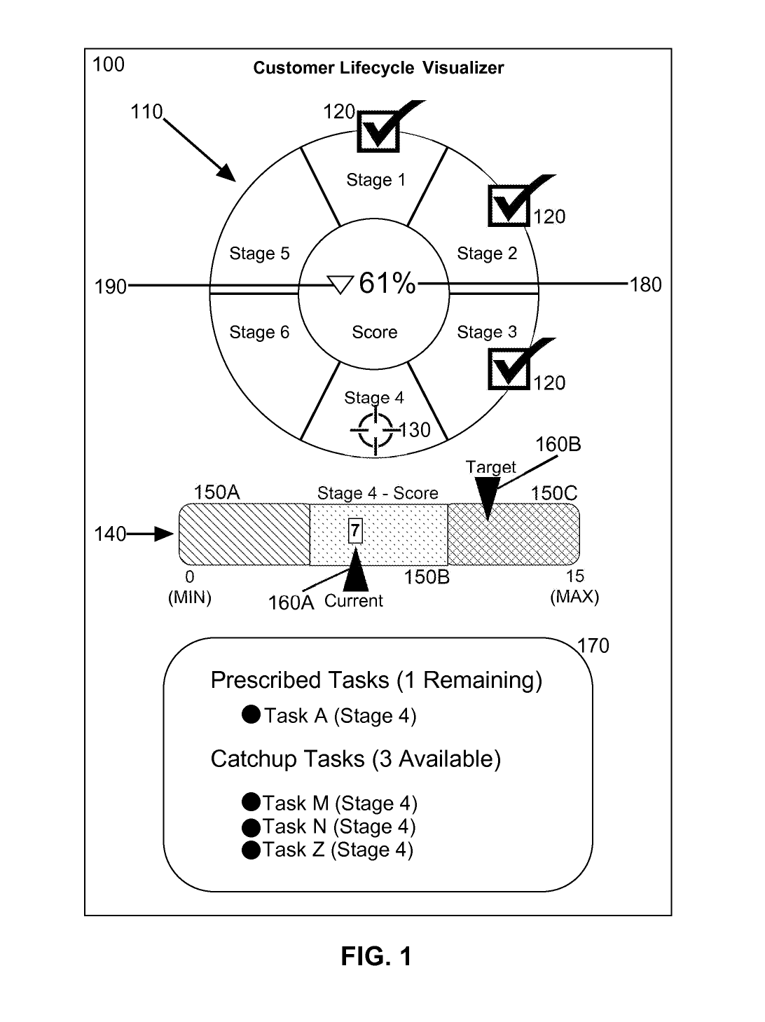

In further illustration, FIG. 1 pictorially shows a process for customer lifecycle management visualization. As shown in FIG. 1, a customer lifecycle visualization tool 100 can be included as part of a user interface of a CRM application and can include a visualization 110 of a customer lifecycle for one or more business opportunities of a customer. The customer lifecycle can be defined by different stages of the customer lifecycle, those stages varying dependent upon a role of an end user utilizing the visualization tool 100. Each of these stages can be defined in a configuration of the visualization tool 100 so as to be completely customizable. A visual indication 130 of a current stage for the opportunity or opportunities can be included in the visualization 110, as can a visual indication 120 for each stage already completed for the opportunity or opportunities.

Of note, different tasks in the CRM application can be associated with different ones of the stages of the customer lifecycle. Each of the tasks can have associated therewith, a value such that a composite score 180 for the customer lifecycle can be computed based upon a sum or a weighted or otherwise adjusted sum of the values of each task completed in connection with the stages of the customer lifecycle already completed as well as the current stage. For example, the sum can be a weighted sum reflecting weighted values for each task dependent upon an identity or role of an individual within a customer organization associated with each of the tasks. The weights and values can be defined separately by way of the configuration of the visualization tool 100. Optionally, the composite score 180 can reflect a percentage based upon of a composite score of the completed tasks relative to a prospective score of an optimal number of tasks able to have been completed for all completed stages and the current stage of the customer lifecycle. As another option, a trend indicator 190 can be included in connection with the composite score 180 visualizing a rate of change positively or negatively of the composite score 180 over time.

With respect to the current stage of the customer lifecycle indicated by the visual indication 130, a stage visualization 140 also is provided. The stage visualization 140 indicates a range of score values available for the tasks associate with the current stage. The stage visualization 140 can be partitioned into different visually distinctive portions 150A, 150B, 150C ranging from a poor score to a good score. The stage visualization 140 additionally can include a current score indicator 160A showing a contemporaneous score based upon all tasks already completed for the current stage, as well as a target score indicator 160B indicating a desired score for the current stage. As noted, the manner in which the contemporaneous score is computed is fully configurable by way of a configuration of the visualization tool 100 and can range from a simple sum of different values for different tasks, to a sum of weighted values to a more complex formulaic manner for computing the contemporaneous score. Finally, the stage visualization 140 includes a task list 170 not only of those tasks already completed for the current stage, but also other tasks not yet completed by available for completion in connection with the current stage.

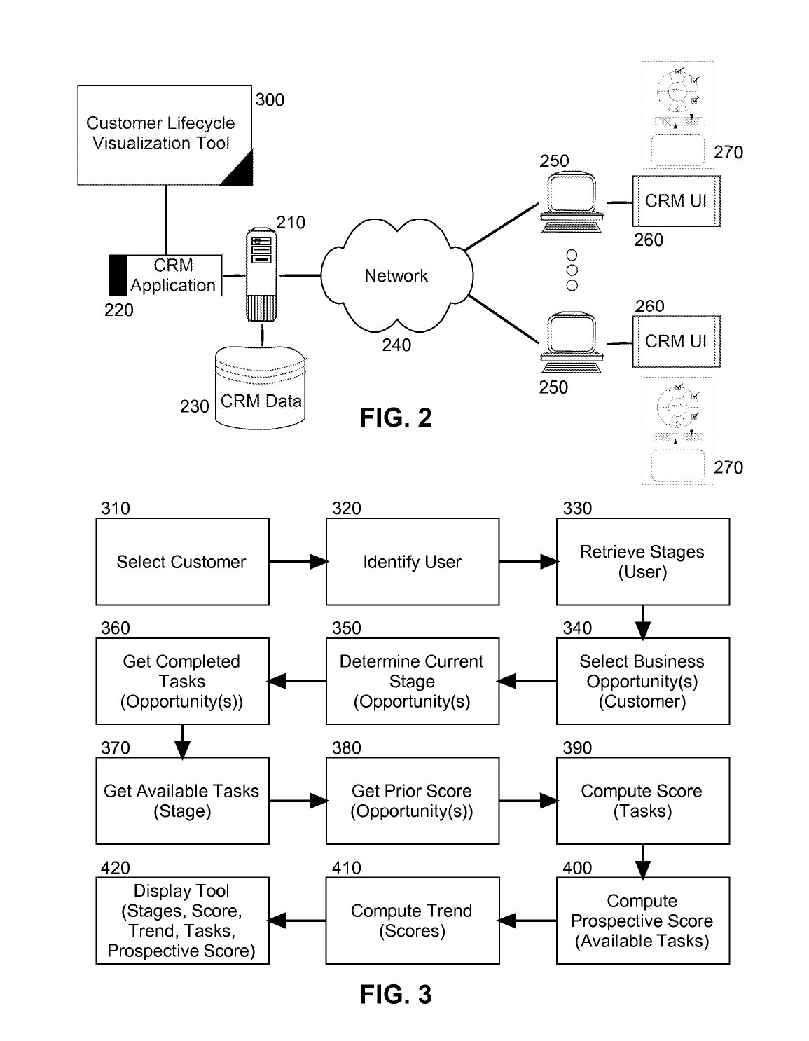

The process described in connection with FIG. 1 is implemented in a CRM data processing system. In further illustration, FIG. 2 schematically shows a CRM data processing system configured for customer lifecycle management visualization. The system includes a host computing system 210 that includes one or more computers each with memory and at least one processor. The host computing system 210 supports the execution of a CRM application 220 providing access to CRM data disposed in a data store 230 coupled to the host computing system 210. Access to the CRM data is provided to each different client computer 250 over computer communications network 240 by way of a respectively different CRM user interface 260.

Of note, a customer lifecycle visualization tool 300 is coupled to the CRM application 220. The customer lifecycle visualization tool 300 includes program code that when executed in the memory of the host computing system 210 is enabled to define a customer lifecycle of different stages and to associate different tasks of the CRM application 220 with the different stages of the customer lifecycle. The program code is additionally able to generate a visualization 270 of the progress of customer lifecycle for a particular business opportunity of a corresponding customer or set of business opportunities of a corresponding customer. In this regard, those stages of the lifecycle already completed are visually differentiated in the visualization 270 as compared to those stages of the lifecycle not yet completed as well as a current stage of the lifecycle.

Optionally, the program code is enabled to compute an aggregate score for the business opportunity based upon a sum of values assigned to each task already completed for the business opportunity. As another option, a list of tasks not yet completed for a current stage of the lifecycle for the business opportunity can be presented so as to indicate tasks able to be completed in order to boost the aggregate score. As yet another option, a visualization of a score for tasks completed just for the current stage of the lifecycle for the business opportunity can be presented by the program code in the visualization 270.

In yet further illustration of the operation of the customer lifecycle visualization tool 300, FIG. 3 is a flow chart illustrating a process for customer lifecycle management visualization. Beginning in block 310, a customer is selected in the CRM application and a user interacting with the CRM application is also identified in block 320. In block 330, different stages of a customer lifecycle are retrieved in connection with a role of the identified end user and in block 340, one or more business opportunities for the selected customer are further selected.

Thereafter, in block 350 a current stage of the customer lifecycle is determined for the selected business opportunities and in block 360, those tasks already completed for the selected business opportunities are identified as are available and yet to be completed tasks for the current stage in block 370. In block 380, a prior aggregate score for the completed tasks of the customer lifecycle for the selected business opportunities is retrieved and in block 390, a new aggregate score is computed based upon score values assigned to each of the completed tasks. As well, in block 400 a prospective score is computed based upon score values for tasks not yet completed for the current stage.

In block 410, a trend of the aggregate score is determined by comparing the new aggregate score with the prior aggregate score. Finally, in block 420, a visualization tool is displayed in connection with the CRM application by visualizing the stages of the customer lifecycle, visually distinguishing completed stages from yet to be completed stages, including in the visualization the new aggregate score and an indication of the computed trend, a listing of tasks able to but not yet completed for the current stage, and a prospective score should the identified user perform those tasks.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for customer lifecycle management visualization comprising:
defining multiple different stages of a customer lifecycle in a customer relationship management (CRM) application executing in memory of a computer;
loading records for a business opportunity from a data store of CRM data stored by way of the CRM application;
rendering in a user interface to the CRM application, a visualization of the different stages of the customer lifecycle; and,
displaying a state of the business opportunity within the visualization by visually distinguishing ones of the stages already completed in connection with the business opportunity from ones of the stages not yet completed in connection with the business opportunity.

2. The method of claim 1, further comprising:
identifying from the loaded records different tasks in the CRM application completed in connection with the business opportunity;
computing an aggregate score of the state of the business opportunity based upon a sum of individual scores assigned to respectively different ones of the tasks; and,
displaying the aggregate score within the visualization.

3. The method of claim 2, further comprising:
identifying from a table of tasks in the CRM application, a set of yet to be performed tasks associated with a stage corresponding to the state of the business opportunity; and,
displaying the identified set of yet to be performed tasks in the visualization.

4. The method of claim 3, further comprising:
computing a prospective aggregate score based upon the sum of the individual scores and a sum of scores assigned to the yet to be performed tasks; and,
displaying the computed prospective aggregate score in the visualization in connection with a display of the identified set of yet to be performed tasks.

5. The method of claim 2, wherein the aggregate score is further computed in comparison to a score of a comparable business opportunity.

6. The method of claim 3, wherein the yet to be performed tasks vary based upon a role of an end user directing a viewing of the visualization.

7. A customer relationship management (CRM) data processing system configured for customer lifecycle management visualization, comprising:
a host computing system including one or more computers, each with memory and at least one processor;
a CRM application executing in the memory of the host computing system;
a data store of CRM data coupled to the CRM application; and,
a customer lifecycle management visualization tool coupled to the CRM application and comprising program code enabled upon execution in the memory of the host computing system to define multiple different stages of a customer lifecycle in the CRM application, to load records for a business opportunity from the data store, to render in a user interface to the CRM application, a visualization of the different stages of the customer lifecycle, and to display a state of the business opportunity within the visualization by visually distinguishing ones of the stages already completed in connection with the business opportunity from ones of the stages not yet completed in connection with the business opportunity.

8. The system of claim 7, wherein the program code is further enabled to:
identify from the loaded records different tasks in the CRM application completed in connection with the business opportunity;
compute an aggregate score of the state of the business opportunity based upon a sum of individual scores assigned to respectively different ones of the tasks; and,
display the aggregate score within the visualization.

9. The system of claim 8, wherein the program code is further enabled to:
identify from a table of tasks in the CRM application, a set of yet to be performed tasks associated with a stage corresponding to the state of the business opportunity; and,
display the identified set of yet to be performed tasks in the visualization.

10. The system of claim 9, wherein the program code is further enabled to:
compute a prospective aggregate score based upon the sum of the individual scores and a sum of scores assigned to the yet to be performed tasks; and,
display the computed prospective aggregate score in the visualization in connection with a display of the identified set of yet to be performed tasks.

11. The system of claim 8, wherein the aggregate score is further computed in comparison to a score of a comparable business opportunity.

12. The system of claim 9, wherein the yet to be performed tasks vary based upon a role of an end user directing a viewing of the visualization.

13. A computer program product for customer lifecycle management visualization, the computer program product comprising a computer readable storage medium having program instructions embodied therewith, the program instructions executable by a device to cause the device to perform a method comprising:
defining multiple different stages of a customer lifecycle in a customer relationship management (CRM) application executing in memory of a computer;
loading records for a business opportunity from a data store of CRM data stored by way of the CRM application;
rendering in a user interface to the CRM application, a visualization of the different stages of the customer lifecycle; and,
displaying a state of the business opportunity within the visualization by visually distinguishing ones of the stages already completed in connection with the business opportunity from ones of the stages not yet completed in connection with the business opportunity.

14. The computer program product of claim 13, wherein the method further comprises:
identifying from the loaded records different tasks in the CRM application completed in connection with the business opportunity;
computing an aggregate score of the state of the business opportunity based upon a sum of individual scores assigned to respectively different ones of the tasks; and,
displaying the aggregate score within the visualization.

15. The computer program product of claim 14, wherein the method further comprises:
identifying from a table of tasks in the CRM application, a set of yet to be performed tasks associated with a stage corresponding to the state of the business opportunity; and,
displaying the identified set of yet to be performed tasks in the visualization.

16. The computer program product of claim 15, wherein the method further comprises:
computing a prospective aggregate score based upon the sum of the individual scores and a sum of scores assigned to the yet to be performed tasks; and,
displaying the computed prospective aggregate score in the visualization in connection with a display of the identified set of yet to be performed tasks.

17. The computer program product of claim 14, wherein the aggregate score is further computed in comparison to a score of a comparable business opportunity.

18. The computer program product of claim 15, wherein the yet to be performed tasks vary based upon a role of an end user directing a viewing of the visualization.
